(19) United States
(12) Patent Application Publication
(10) Pub. No.: US 2019/0379041 A1
(43) Pub. Date: Dec. 12, 2019

(54) ACTIVE MATERIAL BODY FOR A RECHARGEABLE BATTERY

(71) Applicant: VOLKSWAGEN AKTIENGESELLSCHAFT, Wolfsburg (DE)

(72) Inventors: Thomas SCHLADT, Braunschweig (DE); Tanja GRAF, Braunschweig (DE)

(73) Assignee: VOLKSWAGEN AKTIENGESELLSCHAFT, Wolfsburg (DE)

(21) Appl. No.: 16/439,147

(22) Filed: Jun. 12, 2019

(30) Foreign Application Priority Data
Jun. 12, 2018 (DE) 10 2018 114 009.6

(51) Int. Cl. H01M 4/36; H01M 10/0525; H01M 4/04

(52) U.S. Cl. CPC H01M 4/366; H01M 2004/021; H01M 4/0428; H01M 10/0525

(57) ABSTRACT

An active material body for a rechargeable battery, whereby the active material body comprises at least one active material that has a Young's modulus E_{A} and at least one layered first coating applied on the surface of the active material, whereby the coating consists of a first material that has a first Young's modulus E₁ whereby the following applies: first Young's modulus≤Young's modulus of the active material.

### FIELD OF THE INVENTION

The invention relates to an active material body for a rechargeable battery.

### BACKGROUND OF THE INVENTION

Active material bodies are normally used to form electrodes in a rechargeable battery. A rechargeable battery is an electrochemical-based rechargeable storage unit for electric energy. For instance, lithium-ion rechargeable batteries are known in which the reactive materials (active materials) as well as the electrolyte contain lithium ions in the negative electrode as well as in the positive electrode.

Over the course of their service life, lithium-ion rechargeable batteries undergo capacity and performance losses that can be traced back to a degeneration of the electrodes. An important aspect in this context has to do with (electro)chemical reactions that take place between the active material and the electrolyte on the surface of the active material. The electrolytes disintegrate in this process and a thin layer is formed on the surface of the active material, the so-called solid electrolyte interphase (SEI). The SEI consists primarily of amorphous or partially crystalline compounds containing lithium which are inert from an electrochemical standpoint, that is to say, the lithium ions are no longer capable of participating in the electrochemical processes in the rechargeable battery cell, which ultimately leads to a reduction of the cell capacity. In addition, the reactions on the surface also have a detrimental impact on the active material itself. In the case of the cathode material, a structural transformation can occur on the surface and in the layers close to the surface. In this process, the layer structure (R-3m space group) that is typical for nickel-manganese-cobalt(NMC)-based cathode materials is transformed into a spinel structure (Fd-m3 space group) or even into a sodium chloride structure (Fm-m3 space group). This causes not only a loss in capacity but also a rise in the internal resistance, which can be ascribed to impeded diffusion of the lithium ions through the spinel and sodium chloride structures. Moreover, such transformations are associated with considerable mechanical stresses which markedly reduce the mechanical integrity of the material, even leading to fragmentation or pulverization.

Moreover, another problem is the leaching of transition metal cations (especially manganese) from the surface of the active material. This is caused mainly by hydrofluorocarbon (HFC) which, in turn, is formed in the presence of water during the disintegration of the conducting salts (e.g. LiPF₆) that are present in the electrolyte.

Another aspect of relevance for the degradation of the active materials during operation of the cell is the change in the lattice parameters of the active materials during charging and discharging. Experimental and theoretical experiments have shown, for example, that the crystal lattice of NMC cathode materials can change anisotropically by up to 10% during charging or discharging. This volume change gives rise to intense mechanical stresses not only inside the primary particles but also ultimately in the secondary particles that are made thereof. These mechanical stresses cause cracks to appear between the primary particles which ultimately lead to fracturing of the secondary particles. This brings about pronounced signs ageing such as, for instance, capacity loss. Moreover, the fracturing of the particles creates fresh surfaces that can once again react with the electrolyte and thus further contribute to a loss in the performance of the cell.

Various approaches are known which address the issue of the undesired (electro)chemical reactions on the surface of the active material as well as the ageing phenomena. On the one hand, special additives can be admixed to the electrolyte in order to reduce the undesired reactions with the electrolyte on the surface or else in order to intercept reaction products. Another approach consists of applying a wet/dry chemical coating of inert material to the particles or electrodes. Coatings with aluminum oxide have been developed and are currently being tested by various manufacturers. Moreover, attempts are being made to develop coating materials on the basis of phosphates and oxides which suppress the reaction with the electrolyte on the particle surface but which, at the same time, allow the diffusion of lithium ions.

On the one hand, the admixture of additives reduces the extent of the boundary surface reactivity between the electrolyte and the active material but, on the other hand, it does not completely prevent this, and moreover, this adds another layer of complexity to the system.

Common coating concepts such as, for example, wet/dry chemical coating with aluminum oxide (Al₂O₃) produce, on the one hand, a more or less impermeable covering of the surface of the active material and thus a certain level of protection against undesired reactions, but on the other hand, due to the electrochemically inert nature of Al₂O₃, this is associated with considerable losses in cell performance. This is particularly the case if the coating is electrically poorly conductive (as in the case of Al₂O₃), thereby increasing the electrical resistance between the particles. Another negative aspect is the overall poor conductivity or lithium ions, which likewise causes an increased internal resistance as well as a limitation of the charging capacity.

These two aspects, that is to say, the electrical resistance and the poor lithium ion conductivity, are all the worse the thicker the coating applied onto the active material is. Unfortunately, current coating methods are not able to ensure a sufficiently thin, uniform and impermeable layer on the active materials.

U.S. Pat. No. 8,080,337 B2 discloses a lithium ion rechargeable battery in which the electrodes are formed by a coated active material. The material provided here as the coating of the active material has a higher Young's modulus than the active material does.

Up until now, these problems have been circumvented, for example, in that a rechargeable battery management system was employed in an attempt to prevent critical load points during operation. In this context, rapid-charge procedures are avoided or their speed is reduced as much as possible since otherwise, they can greatly shorten the service life of the rechargeable battery.

### SUMMARY OF THE INVENTION

The objective of the present invention is to at least partially overcome the problems described above with reference to the state of the art. In particular, an active material body is to be put forward with which a durable rechargeable battery can be produced that is suitably configured specially for rapid-charge procedures.

An active material body having the features according to the independent claims contribute to achieving these objectives. Advantageous refinements are the subject matter of the dependent patent claims. The features presented individually in the patent claims can be combined with each other in a technically feasible manner and they can be augmented by explanatory facts from the description and/or details from the figures, whereby additional embodiment variants of the invention are put forward.

An active material body for a rechargeable battery is being proposed. The active material body comprises at least one active material that has a Young's modulus E_{A} and at least one layered first coating applied on the surface of the active material. The first coating consists of a first material that has a first Young's modulus E₁ whereby the following applies: first Young's modulus≤Young's modulus of the active material (in other words, the first Young's modulus is lower than or at the maximum equal to the Young's modulus of the active material).

It has been observed that a so-called “egg shell effect” can occur if the active material is coated with a material that has a higher Young's modulus. This happens especially in the case of the conventional materials that are used for coatings of the active materials, For instance, the Young's modulus of aluminum oxide ranges from 300 GPa to 400 GPa [gigapascal], depending on its degree of purity. The Young's modulus of most active materials on the cathode side such as, for instance, NMC materials, is between 100 GPa and 200 GPa. In this combination of a coating with a high Young's modulus and an active material with a lower Young's modulus, even a moderate mechanical load can already lead to crack formation and can cause the coating to peel off. Moreover, the problem of particle fragmentation or crack formation cannot be prevented by these brittle coatings. The coating peels off under the mechanical load, be it due to external mechanical influences or due to the load-related volume change of the primary particles, as a result of which the coating properties are lost.

In contrast, it is now being proposed for the active material to be provided with at least a first coating that has a lower Young's modulus than the active material does.

In particular, the Young's modulus E₁ is at least 10%, especially at least 20%, lower than the Young's modulus E_{A}.

Preferably, at least the first coating has a first thickness of 2 nanometers at the maximum, preferably 1 nanometer at the maximum.

The thickness is measured especially along the shortest distance between the surface of the active material and the surface of the first coating.

In particular, at least the first material is an inorganic ceramic.

In particular, the coating material chosen for the first material is one whose physical-chemical material properties provide protection in the form of a physical barrier. Moreover, the Young's modulus E₁ should be lower than or at the maximum equal to the Young's modulus E_{A} of the active material. In particular, inorganic ceramic materials that stand out for their high thermodynamic stability (that is to say, clearly negative free enthalpy of formation) are provided as first materials. Owing to the low conductivity of many inorganic ceramic compounds, the thickness of the first coating should be only in the low nanometer range.

Preferably, the active material body comprises at least one n^{th} coating arranged on the surface of an n^{th}−1 coating, whereby the n^{th} coating consists of an n^{th} material with an n^{th} Young's modulus Eₙ, wherein n=2, 3, 4, . . . , whereby the following applies: n^{th} Young's modulus≤n^{th}−1 Young's modulus≤Young's modulus of the active material.

In particular, it is being proposed for the active material body to have a multi-functional coating that consists of several components, whereby each component is systematically adapted to the requirements of the active material and to those of the surroundings (especially the electrolyte). These requirements are especially characterized by (electro)chemical or physical compatibility, and preferably alternatively or additionally, by mechanical compatibility.

In particular, the first coating serves as a physical barrier, that is to say, it should ensure thermodynamic and structural stability (i.e. maintaining the layer structure in the active material) and, if applicable, also the mechanical integrity. This is especially done by adapting the mechanical properties (such as, for instance, Young's modulus, Poisson's ratio, shear modulus, bulk modulus) to the active material. From an (electro)chemical or physical standpoint, the first coating especially (additionally) has good electrical or lithium-ion conductivity.

In particular, at least two adjacent coatings have Young's moduli that differ by at least 10 GPa [gigapascal] and/or by at least 10% with respect to the Young's modulus (n^{th} is at least 10% smaller than n^{th}−1).

In particular, at least one n^{th} material, wherein n=2, 3, 4, . . . , comprises a purely organic material or an organic-inorganic hybrid material. In particular, a second coating serves as a chemical barrier (against electrolyte, hydrogen fluoride, etc.). From an (electro)chemical or physical standpoint, the second coating especially (additionally) has good electrical or lithium-ion conductivity.

The n^{th} material, wherein n=2, 3, 4, . . . , especially comprises purely organic compounds, for example, various polymers, or else organic-inorganic hybrid polymers such as, for instance, alucones.

In particular, an n^{th} coating has an n^{th} thickness, wherein n=2, 3, 4, . . . , whereby at least one of the n^{th} thicknesses is at least equal to a first thickness of the first coating.

In particular, none of the n^{th} thicknesses wherein, n=2, 3, 4, . . . , is thicker than 5 nanometers.

The thickness of the n^{th} coating can be greater than that of the first coating since the organic or organic-inorganic hybrid materials display better lithium-ion conductivities.

In particular, the properties of the n^{th} coating vis-à-vis those of the first coating are as compared to selected in such a way that, with each coating that is arranged further towards the outside, the mechanical properties are set towards less brittleness, lower Young's modulus, lower shear modulus, lower bulk modulus.

At least the first coating can be applied onto the surface of the active material by means of a chemical vapor deposition method.

In particular, preference is given to coating methods which allow a precise control of the resultant material properties of each coating. Moreover, coating methods are preferred which allow a high degree of control for the individual layer thickness. Since the individual layer thickness should only be within the range of a few nanometers (especially 1 to 5 nanometers), preference should be given to chemical vapor deposition methods such as, for instance, atomic layer deposition (ALD) and/or molecular layer deposition (MLD).

In particular, the active material contains lithium ions.

A rechargeable battery is also being put forward which comprises at least a negative first electrode, a positive second electrode and an electrolyte that connects the first and second electrodes (so as to be electrically non-conductive but (lithium)ion-conductive), whereby at least one of the electrodes comprises the described active material body.

The elaborations pertaining to the rechargeable battery likewise apply to the active material and vice versa.

Aside from the mere protection of the surface of the active material, other intrinsic properties of the materials of the coatings which are of relevance during operation of the rechargeable battery are likewise described here. In particular, ensuring mechanical integrity during repeated charging and discharging cycles constitutes an essential feature of the (multifunctional) coating described here.

Moreover, the use of a multilayer system in which the Young's moduli become increasingly lower towards the outside (starting from the active material and extending through the individual coatings) has the advantage that damage to the inner layers (caused, for example, by volume changes in the substrate or in the active material) cannot propagate towards the outside. In other words, even in the case of a (partial) failure of the inner coatings, the mechanical integrity of the entire system (active material body) is retained.

Furthermore, the presence of a softer outer layer means that mechanical loads of the type that occur during the production of the rechargeable battery itself can be better absorbed, so that fewer stresses occur in the coatings near the active material and, for example, in the active material itself.

The simulation of von Mises stress in the active material body having several coatings has shown that the stress in the active material is considerably reduced by the presence of several coatings. Moreover, the coating system can buffer the volume change of the active material (by virtue of the gradual change in the mechanical properties). This might not be able to prevent crack formation. However, crack propagation and the resultant fragmentation can be prevented so that the particles are held together by the coating(s).

Thanks to the arrangement of one or more coatings on the active material, whereby the (electro)chemical as well as the mechanical properties are adapted to the requirements of the active material as well as to the chemical environment of the rechargeable battery, it is possible to overcome the drawbacks of the active materials and rechargeable batteries described above. The poor electrical and lithium-ion conductivity of aluminum oxide is improved by employing other suitable materials having a higher conductivity. The use of ceramic materials for the first coating ensures sufficient physical and chemical protection against undesired surface reactions with the electrolyte. The adaptation of the mechanical properties (Young's modulus, shear modulus, bulk modulus, Poisson's ratio) of the first coating to the active material situated underneath it increases the mechanical integrity by stabilizing the crystal lattice. Moreover, the mechanical flexibility of the n^{th} coating, wherein n=2, 3, 4, . . . , allows a greater change in volume during charging or discharging, thus preventing fragmentation or even pulverization of the secondary particles.

The solutions known so far comprise wet or dry-chemical coating methods in which the resultant coatings exhibit a large and non-uniform thickness as well as lower impermeability (so-called pin holes). The first aspect has a very negative impact on the conductivity, whereas the second aspect leads to local reaction centers on the surface, where even stronger reactions with the electrolyte can then occur.

Through the use of coating methods entailing a high degree of process control and coating uniformity (such as, for instance, the ALD method), a very thin layer as well as a high level of impermeability can be achieved for each individual component.

The proposed active material body or the rechargeable battery can especially be used in motor vehicles (passenger cars, buses, trucks) that operate with lithium-ion rechargeable batteries or electric drives or with a fuel cell drive. As an alternative, they can be used for other mobile applications (electric bicycles) or consumer electronics or for stationary applications.

A preferred embodiment being put forward is an active material body having at least two coatings. For instance, the active material consists of NMC 111, the first coating consists of LiF and the second coating consists of a polymer. The Young's moduli are as follows: E_{A}=120 GPa, E₁=81 GPa, E₂=20 GPa.

For the sake of clarity, it should be mentioned that the ordinal numbers employed (“first”, “second”, etc.) serve primarily (merely) to differentiate among several similar objects, parameters or processes, in other words, they do not necessarily prescribe any dependence and/or sequence of these objects, parameters or processes. Should a dependence and/or sequence be necessary, this will be explicitly indicated or else it is obviously inferred by the person skilled in the art upon examination of the concrete embodiment being described.

### BRIEF DESCRIPTION OF THE DRAWINGS

The invention as well as the technical field will be explained in greater detail below on the basis of the accompanying figures. It should be pointed out that the invention should not be construed as being limited by the embodiments given. In particular, unless otherwise indicated explicitly, it is also possible to extract partial aspects of the facts elucidated in the figures and to combine them with other constituents and insights stemming from the present description. In particular, it should be pointed out that the figures and especially the size relationships are only of a schematic nature. The following is shown:

FIG. 1: an active material body;

FIG. 2: a first embodiment variant of an active material body;

FIG. 3: a second embodiment variant of an active material body;

FIG. 4: a third embodiment variant of an active material body;

FIG. 5: a diagram showing the possible variations of the Young's moduli of the individual coatings for the active material body shown in FIG. 3;

FIG. 6: a diagram showing the possible variations of the Young's moduli of the individual coatings for the active material body shown in FIG. 4;

FIG. 7: a layer failure due to a change in the volume of the active material;

FIG. 8: crack propagation in the active material body shown in FIG. 3;

FIG. 9: a comparison between the active material bodies shown in FIGS. 7 and 8;

FIG. 10: damage to the active material body upon application of an external mechanical load;

FIG. 11: damage to the active material body shown in FIG. 2 upon application of an external mechanical load;

FIG. 12: damage to the active material body shown in FIG. 3 upon application of an external mechanical load;

FIG. 13: a simulation of a mechanical load on an active material (without coating);

FIG. 14: a simulation of a mechanical load on an active material body shown in FIG. 2;

FIG. 15: a simulation of a mechanical load on an active material body shown in FIG. 3; and

FIG. 16: a rechargeable battery.

### DETAILED DESCRIPTION OF THE INVENTION

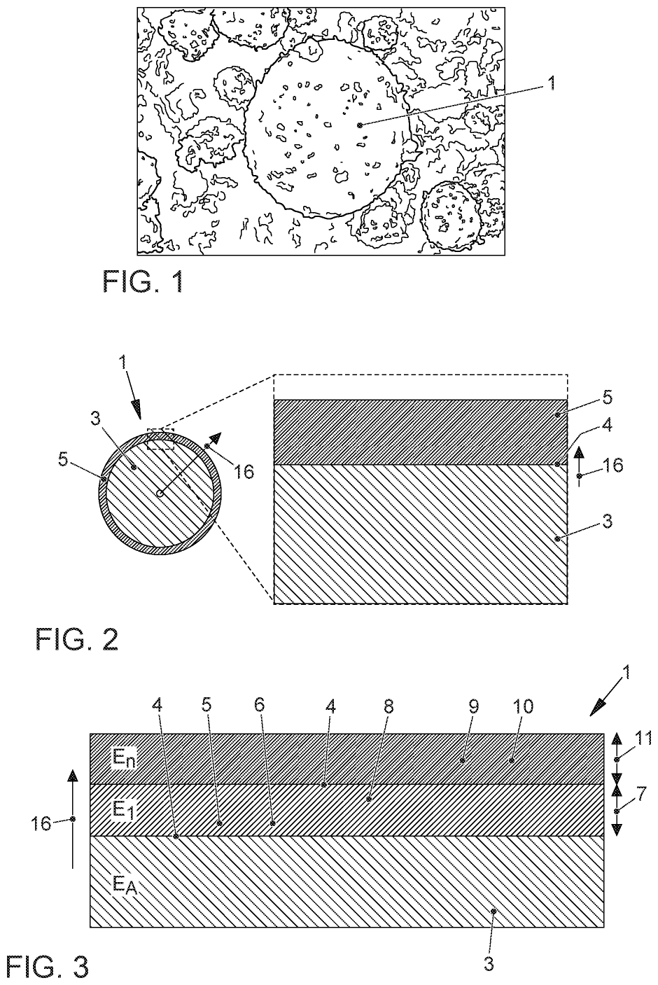

FIG. 1 shows an active material body 1 (here a cathode material) imaged by means of a scanning electron microscope (SEM).

FIG. 2 shows a first embodiment variant of an active material body 1 having an active material 3 and a first coating 5 on the surface 4 of the active material 3. The first coating 5 is arranged in the radial direction 16 outside of the (spherical) active material 3.

FIG. 3 shows a second embodiment variant of an active material body 1. Reference is hereby made to the elaborations pertaining to FIG. 2.

The present active material body 1 has a first coating 5, 8 with a first thickness 7 and a second coating 9 with a second thickness 11. The first coating 5, 8 comprises a first material 6, and the second coating 9 has a second thickness 11. Starting from the active material 3, the Young's moduli E_{A}, E₁, E₂ diminish with each coating 5, 8, 9.

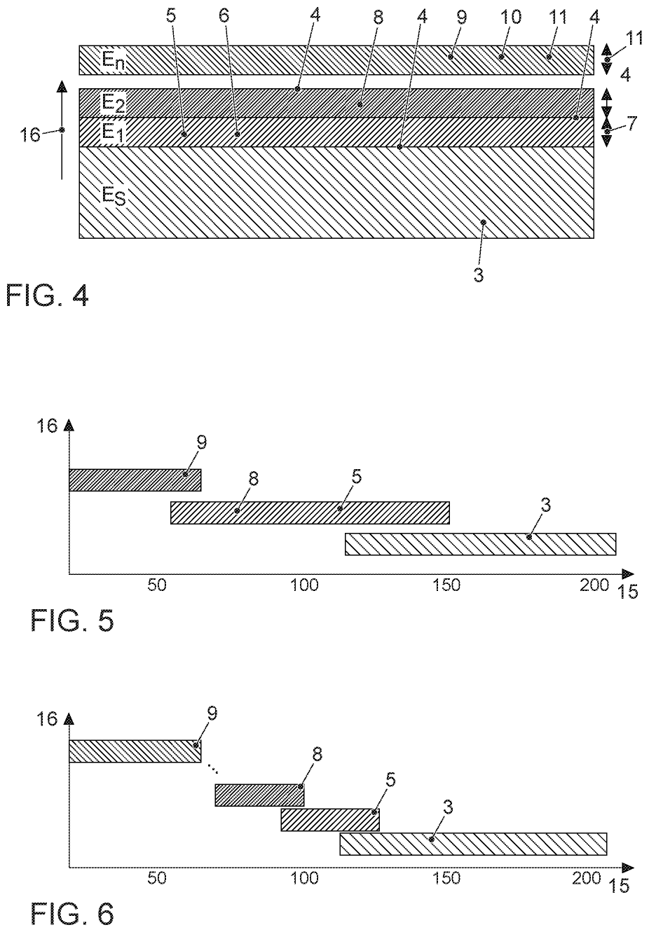

FIG. 4 shows a third embodiment variant of an active material body 1. Reference is hereby made to the elaborations pertaining to FIG. 3.

Diverging from the second embodiment variant, the present active material body 1 has an additional n^{th} (third) coating 9 consisting of an n^{th} material 10 having an n^{th} thickness 11.

FIG. 5 depicts a diagram showing the possible variations of the Young's moduli of the individual coatings 5, 8, 9 (and of the active material 3) for the active material body 1 shown in FIG. 3. Reference is hereby made to the elaborations pertaining to FIG. 3.

The radial direction 16 is plotted on the vertical axis. The Young's modulus 15 is plotted on the horizontal axis.

FIG. 6 depicts a diagram showing the possible variations of the Young's moduli of the individual coatings 5, 8, 9 (and of the active material 3) for the active material body 1 shown in FIG. 4. Reference is hereby made to the elaborations pertaining to FIGS. 4 and 5.

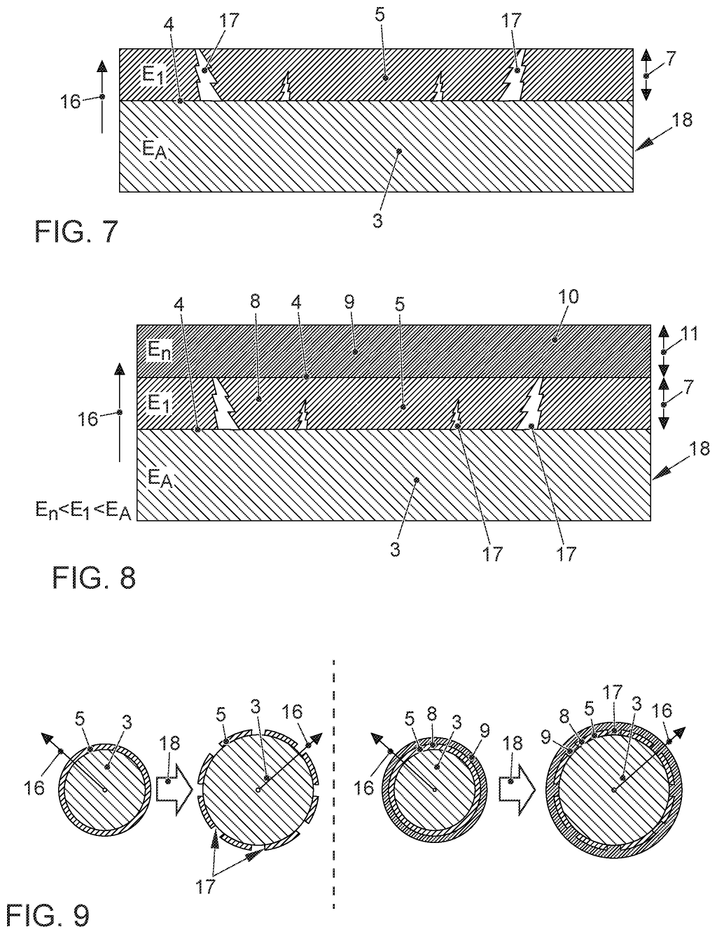

FIG. 7 shows a layer failure due to a volume change 18 of the active material 3 or of the active material body 1 shown in FIG. 2. Reference is hereby made to the elaborations pertaining to FIG. 2.

The cracks 17 are formed on the surface 4 of the active material 3 and they propagate towards the outside in the first coating 5 along the radial direction 16.

FIG. 8 depicts crack propagation in the active material body 1 shown in FIG. 3. Reference is hereby made to the elaborations pertaining to FIGS. 7 and 3.

Here, it is shown that the propagation of the cracks 17 can be stopped by means of the second coating 9.

FIG. 9 shows a comparison between the active material bodies 1 shown in FIGS. 7 and 8. Reference is hereby made to the elaborations pertaining to FIGS. 7 and 8.

On the left-hand side of FIG. 9, one can see the active material body 1 as shown in FIG. 7 before (on the left) and after (on the right) the volume change 18. It can be seen here that the first coating 5 no longer completely covers the active material 3 after the volume change 18.

On the right-hand side of FIG. 9, one can see the active material body 1 as shown in FIG. 8 before (on the left) and after (on the right) the volume change 18. It can be seen here that the first coating 5 can no longer completely cover the active material 3 after the volume change 18. However, there is a second coating 9 that continues to cover the active material 3.

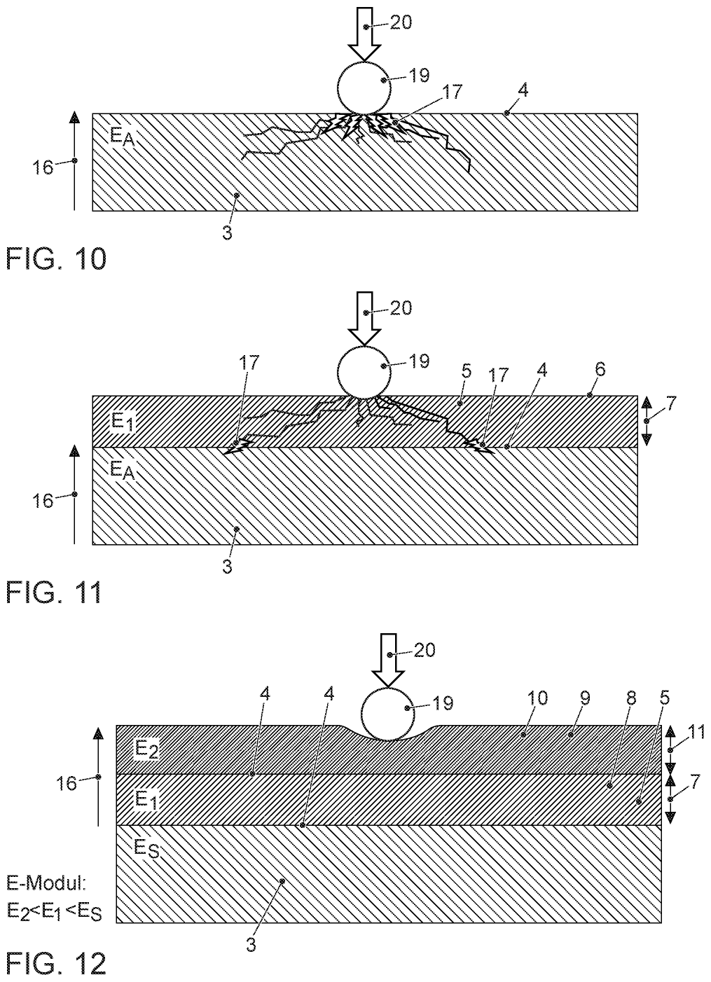

FIG. 10 shows damage to the active material body 1 upon application of an external mechanical load or force 20. In this process, a ball 19 is struck with a force 20 against the surface 4 of the active material 3. This results in crack formation and fragmentation of the active material 3.

FIG. 11 shows damage to the active material body 1 shown in FIG. 2 upon application of an external mechanical load or force 20. In this context, reference is made to the elaborations pertaining to FIGS. 2 and 10.

The cracks 17 propagate through the first coating 5 all the way into the active material 3.

FIG. 12 shows damage to the active material body 1 shown in FIG. 3 upon application of an external mechanical load or force 20. In this context, reference is made to the elaborations pertaining to FIGS. 3 and 10 or 11.

The second coating 9 is deformed by the ball 19. Owing to the low Young's modulus 15 of the second coating 19, however, the only thing that happens is a deformation of the second coating 9, but no formation of cracks 17.

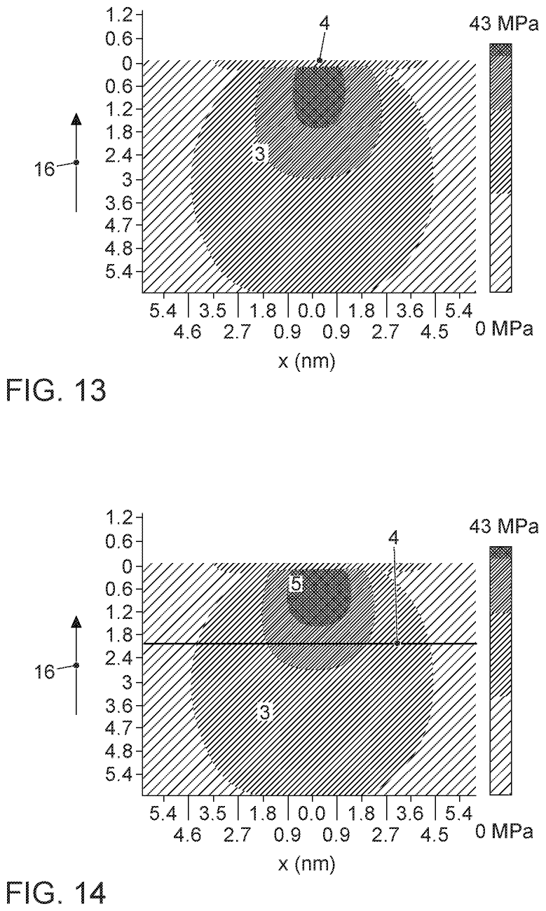

FIG. 13 shows a simulation of a mechanical loading of an active material 3 (without coating). The radial direction 16 that starts at the surface 4 is plotted on the vertical axis. The scale for the ascertained stresses is shown on the right-hand side of the diagram. A path 21 along the active material body 1 (parallel to the surface 4) is shown on the horizontal axis.

FIGS. 13, 14 and 15 each show a Van Mises stress distribution. The maximum value of the stress in FIG. 13 is 43.7 MPa [megapascal] (here in the active material 3). The active material 3 is NMC 111. The Young's modulus of the active material 3 is 120 GPa.

FIG. 14 shows a simulation of a mechanical loading of an active material 3 shown in FIG. 2. In this context, reference is made to the elaborations pertaining to FIG. 13 and FIG. 2.

It can be clearly seen that the stresses in the active material 3 (below the line) are reduced.

The maximum value of the stress in FIG. 14 is 38.3 MPa [megapascal] (here in the first coating 5). The active material 3 is NMC 111. The Young's modulus of the first coating 5 is 81 GPa (here LiF).

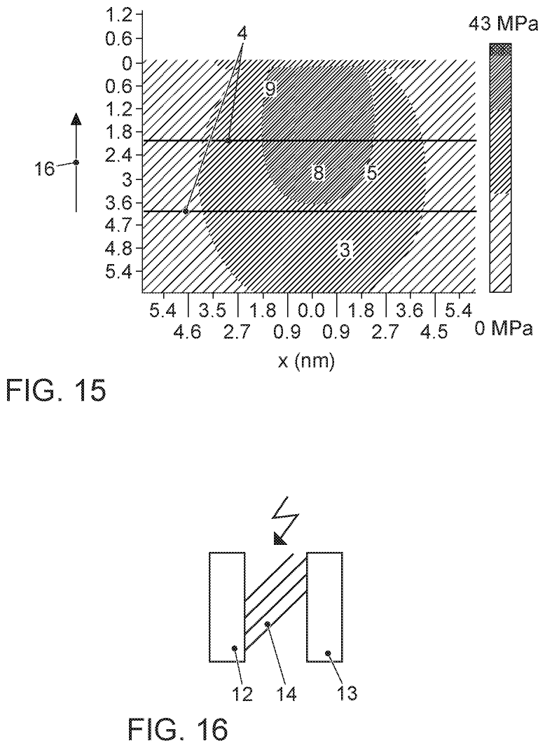

FIG. 15 shows a simulation of a mechanical loading of an active material body 1 shown in FIG. 3. In this context, reference is made to the elaborations pertaining to FIGS. 13, 14 and FIG. 3.

It can be clearly seen that the stresses in the active material body 1 (in other words, also in the coatings 5, 8, 9) are reduced.

The maximum value of the stress in FIG. 15 is 19.35 MPa [megapascal] (here in the second coating 9). The active material 3 is NMC 111. The Young's modulus of the first coating 5 is 81 GPa (here LiF). The Young's modulus of the second coating 9 is 20 GPa (here polymer).

FIG. 16 shows a rechargeable battery 2 with a negative first electrode 12, a positive second electrode 13 and an electrolyte 14 that connects the first electrode 12 and the second electrode 13 so as to conduct ions.

### LIST OF REFERENCE NUMERALS

1 active material body
2 rechargeable battery
3 active material
4 surface
5 first coating
6 first material
7 first thickness
8 n^{th}−1 coating
9 n^{th} coating
10 n^{th} material
11 n^{th} thickness
12 first electrode
13 second electrode
14 electrolyte
15 Young's modulus [GPa]
16 radial direction
17 crack
18 volume change
19 ball
20 force
21 path

1. An active material body for a rechargeable battery, the active material body comprising:
at least one active material that has a Young's modulus E_{A}, and
at least one layered first coating applied on a surface of the active material,
whereby the first coating consists of a first material that has a first Young's modulus E₁, and
whereby the following applies: first Young's modulus≤Young's modulus of the active material.

2. The active material body according to patent claim 1, whereby at least the first coating has a first thickness of 2 nanometers at the maximum.

3. The active material body according to claim 1, whereby at least the first material is an inorganic ceramic.

4. The active material body according to claim 1,
whereby the active material body comprises at least one n^{th} coating arranged on the surface of an n^{th}−1 coating,
whereby the n^{th} coating consists of an n^{th} material with an n^{th} Young's modulus Eₙ, wherein n=2, 3, 4, . . . , and
whereby the following applies: n^{th} Young's modulus≤n^{th}−1 Young's modulus≤Young's modulus of the active material.

5. The active material body according to claim 4, whereby at least two adjacent coatings have Young's moduli E₁, Eₙ that differ from each other by at least 10 GPa [gigapascal].

6. The active material body according to claim 4, whereby at least one n^{th} material, wherein n=2, 3, 4, . . . , comprises a purely organic material or an organic-inorganic hybrid material.

7. The active material body according to claim 4,
whereby an n^{th} coating has an n^{th} thickness, wherein n=2, 3, 4, . . . , and
whereby at least one of the n^{th} thicknesses is at least equal to a first thickness of the first coating.

8. The active material body according to claim 1, whereby at least the first coating is applied onto the surface of the active material by means of a chemical vapor deposition method.

9. The active material body according to claim 1, whereby the active material contains lithium ions.

10. A rechargeable battery comprising:
at least a negative first electrode,
a positive second electrode, and
an electrolyte that connects the first electrode and the second electrode,
whereby at least one of the electrodes comprises an active material body according to claim 1.
